(19) United States
(12) Patent Application Publication
(10) Pub. No.: US 2026/0034498 A1
(43) Pub. Date: Feb. 5, 2026

(54) CONTINUOUS CARBON DIOXIDE CAPTURE SYSTEM FOR INCREASING ADSORPTION EFFICIENCY AND REGENERATION PURITY AND METHOD OF OPERATING THE SAME

(71) Applicant: KOREA INSTITUTE OF ENERGY RESEARCH, Daejeon (KR)

(72) Inventors: Jae Young Kim, Daejeon (KR); Gyoung-tae Jin, Daejeon (KR); Young Cheol Park, Daejeon (KR); Sung-ho Jo, Daejeon (KR); Jae-hyeon Park, Daejeon (KR); Dong-Ho Lee, Daejeon (KR); Yu Ri Lee, Daejeon (KR); YUNTAE HWANG, Daejeon (KR); Jeong Min Kim, Daejeon (KR); Hyun-seol Park, Daejeon (KR); Dong-hyuk Chun, Daejeon (KR); Hyunuk Kim, Daejeon (KR); Dong-Kyu Moon, Daejeon (KR)

(73) Assignee: KOREA INSTITUTE OF ENERGY RESEARCH, Daejeon (KR)

(21) Appl. No.: 19/287,442

(22) Filed: Jul. 31, 2025

(30) Foreign Application Priority Data
Aug. 1, 2024 (KR) 10-2024-0102336

(51) Int. Cl. B01D 53/04; B01D 53/26

(52) U.S. Cl. CPC B01D 53/0438; B01D 53/0446; B01D 53/265; B01D 2257/504; B01D 2257/80; B01D 2259/4009

(57) ABSTRACT

The present disclosure relates to a continuous carbon dioxide capture system for increasing adsorption efficiency and regeneration purity, more particularly to, as a continuous carbon dioxide capture system, a continuous direct air capture system with a low differential pressure for increasing adsorption efficiency and regeneration purity including: an adsorption unit including a housing having an inlet part for introducing external air and an outlet part for discharging carbon dioxide-removed air, and a plurality of adsorbent modules installed within the housing and composed of carbon dioxide adsorbents, wherein the adsorption unit is connected in plurality, and the adsorption unit sequentially undergoes adsorption mode and regeneration mode and always operates in adsorption mode in a set number of adsorption units; a suction valve provided at the inlet part for introducing external air, and an outlet valve provided at the outlet part for exhausting the gas passed through the adsorbent modules; and a controller for controlling the suction valve and the outlet valve according to the adsorption mode and the regeneration modes, respectively.

### CROSS-REFERENCE TO RELATED APPLICATIONS

This application claims priority to and the benefit of Korea Patent Application No. 10-2024-0102336 filed in the Korean Intellectual Property Office on Aug. 1, 2024, the contents of which are incorporated herein by reference in their entirety.

### BACKGROUND

### Technical Field

The present disclosure relates to a continuous carbon dioxide capture system for increasing adsorption efficiency and regeneration purity and a method of operating the same.

### Related Art

In order to limit the global temperature rise to below 1.5 degrees Celsius, negative carbon emission technologies are required, and a direct air capture (DAC) from the atmosphere represents one of the feasible options.

It is necessary to overcome the limitations of conventional CCS (CO₂ capture and storage) technologies that capture CO₂ from large-scale sources with high CO₂ concentrations and to shift the paradigm toward small-scale, distributed CO₂ capture. DAC has been evaluated as a technology capable of capturing CO₂ from the atmosphere regardless of time and location, and removing 3.6 to 12 billion tons of CO₂ annually worldwide (NASEM report, 2018).

Although the high cost of direct air capture of CO₂ from the atmosphere has been raised as an issue, recently it has been reported that the capture cost can be reduced to below $100 per ton of CO₂.

Furthermore, it is capable of producing numerous products from carbon captured from the air (thereby obtaining remarkable economic value from one of the major climate change substances currently emitted as waste).

In addition, there is an increasing demand for technologies that remove and treat CO₂ from part of the circulating air in heating, ventilation, and air conditioning systems for building.

Currently, such systems are operated to adsorb carbon dioxide during certain periods (work hours), and then to regenerate the purified air and release it outside during lunch breaks or after work hours.

In such carbon dioxide capture and recovery technologies, a low pressure drop process is crucial. In other words, it is important to lower the pressure drop that occurs as air passes through the adsorbent module. There are conventional techniques that lower the pressure drop by increasing the particle size of the adsorbent. However, increasing the adsorbent particle size has the drawback of reducing contact efficiency and adsorption performance.

Moreover, the carbon dioxide capture and utilization industry is expected to reach $800 billion (approximately, 800 trillion KRW) by 2023. Even non-oil-producing countries that currently pay high prices will be able to produce fuel through air capture, potentially leading to the equalization of fuel costs.

In the case of CO₂ capture systems incorporated with air purifiers, they have been introduced to the market as high-end products for home, vehicle, and classroom use.

However, such conventional direct air capture devices do not operate in a continuous manner, but alternate between reactors for regeneration, resulting in the drawback of requiring additional energy consumption and time for heating and cooling.

### RELATED ART DOCUMENT

### Patent Document

(Patent Document 1) JP Laid-Open Patent Publication JP2012-520766

(Patent Document 2) JP Patent No. 5932771

(Patent Document 3) JP Laid-Open Patent Publication JP2016-26113

(Patent Document 4) JP Laid-Open Patent Publication JP2020-32422

### DETAILED DESCRIPTION

### Technical Problem

Therefore, the present disclosure is contrived to address conventional issues as described above. It aims to provide a continuous carbon dioxide capture system for increasing adsorption efficiency and regeneration purity and a method of operating the same by introducing an N₂ regeneration mode between the CO₂ generation mode and the cooling mode, according to an embodiment of the present disclosure.

Further according to an embodiment of the present disclosure, it aims to provide a continuous carbon dioxide capture system for increasing adsorption efficiency and regeneration purity and a method of operating the same, which are capable of handling a large flow rate while minimizing pressure drop, and enables continuous direct air capture without interrupting the adsorption reaction process by continuously performing a cyclic operation of adsorption mode, preheating mode, first heating mode, second heating mode, CO₂ regeneration mode, N₂ regeneration mode, cooling mode, and adsorption mode based on the regeneration cycle of the adsorbent, by the adsorbent or adsorbent module embedded in the adsorption tower.

Yet further, according to an embodiment of the present disclosure, multiple adsorption units are interconnected in an array. Accordingly, a set number of adsorption units are always operating in adsorption mode, thereby achieving continuous direct air capture operation.

Yet further, according to an embodiment of the present disclosure, it aims to provide a continuous carbon dioxide capture system for increasing adsorption efficiency and regeneration purity and a method of operating the same, which are capable of sequentially determining: the number of adsorption units required to operate in adsorption mode within the installation space; the durations needed for adsorption, heating, regeneration, and N₂ regeneration-cooling steps; and the total number of adsorption units so as to match the number of adsorption units required to operate in the determined adsorption mode.

Meanwhile, the technical objects to be achieved by the present disclosure are not limited to those mentioned above, and other technical objects, which are not explicitly stated herein, will be readily understood by those of ordinary skill in the art from the following description.

### Technical Solution

According to a first aspect of the present disclosure, it can be achieved by a continuous carbon dioxide capture system for increasing adsorption efficiency and regeneration purity including: a housing that includes an air inlet port through which external air is introduced and an outlet port through which carbon dioxide-removed air is discharged; and an adsorption unit that is installed within the housing and configured with a carbon dioxide adsorbent, wherein the adsorption unit is connected in plurality and sequentially undergoes an adsorption mode, a heating mode, a CO₂ regeneration mode, and a nitrogen regeneration-cooling mode, such that a set number of adsorption units always operate in the adsorption mode; and a regeneration circulation line that connects an adsorption unit in the heating mode to an adsorption unit in the regeneration mode.

Further, each of the plurality of adsorption units sequentially undergoes an adsorption mode, a preheating mode, a first heating mode, a second heating mode, a CO2 regeneration mode, an N2 regeneration-cooling mode, and an adsorption mode, and a set number of the adsorption units always operate in the adsorption mode.

Yet further, the continuous carbon dioxide capture system for increasing adsorption efficiency and regeneration purity further includes: a cooling circulation line that connects an outlet port of the adsorption unit in the preheating mode and an inlet port of an adsorption unit in a cooling step of the N₂ regeneration-cooling mode, and connects an outlet port of the adsorption unit in the cooling step of the N₂ regeneration-cooling mode and an inlet port of the adsorption unit in the preheating mode.

Yet further, the continuous carbon dioxide capture system for increasing adsorption efficiency and regeneration purity further includes: an N₂—CO₂ purge line for purging N₂—CO₂ into the adsorption unit in preheating mode; and a first valve provided on one side of the N₂—CO₂ purge line.

Yet further, the continuous carbon dioxide capture system for increasing adsorption efficiency and regeneration purity further includes: an N₂ regeneration circulation line that connects an outlet port of the adsorption unit in the first heating mode and an inlet port of an adsorption unit in an N₂ regeneration step of the N₂ regeneration-cooling mode, and connects an inlet port of the adsorption unit in the N₂ regeneration step and an inlet port of the adsorption unit in the first heating mode; and a CO₂ purge line purging CO₂ into the adsorption unit in the first heating mode.

Yet further, the continuous carbon dioxide capture system for increasing adsorption efficiency and regeneration purity further includes: a discharge line through which N₂—CO₂ is discharged from the adsorption unit in the first heating mode; and a second valve provided on one side of the discharge line.

Yet further, the continuous carbon dioxide capture system for increasing adsorption efficiency and regeneration purity further includes an N₂—CO₂ buffer tank provided between the N₂—CO₂ purge line and the discharge line.

Yet further, the continuous carbon dioxide capture system for increasing adsorption efficiency and regeneration purity further includes a regeneration circulation line that connects an outlet port of the adsorption in the second heating mode and an inlet port of the adsorption unit in the CO₂ regeneration mode, and connects an outlet port of the inlet port of the adsorption unit in the CO₂ regeneration mode and an inlet port of the adsorption unit in the second heating mode.

Yet further, the continuous carbon dioxide capture system for increasing adsorption efficiency and regeneration purity further includes: a condensation line branched from a line that connects the outlet port of the adsorption unit in the second heating mode and the inlet port of the adsorption unit in the CO₂ regeneration mode, and connected to a CO₂ storage tank; and a moisture condensation part provided within the condensation line to condense moisture.

Yet further, the CO₂ purge line is provided between the CO₂ storage tank and the inlet port of the adsorption unit in the first heating mode, and further includes a third valve provided on one side of the CO₂ purge line.

A second aspect of the present disclosure, it can be achieved by, as a method of operating the continuous carbon dioxide capture system according to the aforementioned first aspect of the present disclosure, a method of operating the continuous carbon dioxide capture system for increasing adsorption efficiency and regeneration purity includes: a first step in which an adsorption unit in an adsorption mode allows external air to be introduced through an inlet port, and discharges carbon dioxide-removed air through an outlet port; a second step in which an adsorption unit switched to a preheating mode circulates gas through an adsorption unit in a cooling step of an N₂ regeneration-cooling mode and cooling circulation line; a third step in which an adsorption unit switched to a first heating mode circulates gas through the adsorption unit in the cooling step of the N₂ regeneration-cooling mode and an N₂ regeneration line; a fourth step in which an adsorption unit switched to a second heating mode circulates gas through an adsorption unit in a CO₂ regeneration mode and a regeneration circulation line, and CO₂ discharged through a condensation line branched from one side of the regeneration circulation line is stored in a CO₂ storage tank; a fifth step in which an adsorption switched to a regeneration mode circulates gas through the adsorption unit switched to the second heating mode and the regeneration circulation line, and CO₂ discharged through the condensation line branched from one side of the regeneration circulation line is stored in the CO₂ storage tank; a sixth step in which an adsorption unit moved into a regeneration-cooling unit and switched to an N₂ regeneration step of the N₂ regeneration-cooling mode circulates gas through the adsorption unit in the first heating mode and the N2 regeneration circulation line; a seventh step in which an adsorption unit switched to a cooling step of the N₂ regeneration-cooling mode circulates gas through the adsorption unit in the preheating mode and the cooling circulation line; and a step of repeating the first step to the seventh step. Further, in the second step, N₂ is purged to the adsorption unit, and in the third step, CO₂ is purged to the adsorption unit purges.

Yet further, in the third step, N₂—CO₂ is discharged through an outlet line and stored in a buffer tank, and the N₂—CO₂ stored in the buffer tank is purged to the adsorption unit in the second step.

Yet further, the CO₂ stored in the CO₂ storage tank is supplied to the adsorption unit in the first heating unit through a CO₂ purge line.

### Advantageous Effects

According to a continuous carbon dioxide capture system for increasing adsorption efficiency and regeneration purity and a method of operating the same in accordance of the embodiment of the present disclosure, there are effects of handling a large flow rate while minimizing pressure drop, and enabling continuous direct air capture without interrupting the adsorption reaction process by continuously performing a cyclic operation of adsorption mode, preheating mode, first heating mode, second heating mode, CO₂ regeneration mode, N₂ regeneration mode, cooling mode, and adsorption mode based on the regeneration cycle of the adsorbent, by the adsorbent or adsorbent module embedded in the adsorption tower.

Additionally, according to an embodiment of the present disclosure, multiple adsorption units are interconnected in an array. Accordingly, a set number of adsorption units are always operating in adsorption mode, thereby achieving continuous direct air capture operation.

Further, according to a continuous carbon dioxide capture system for increasing adsorption efficiency and regeneration purity and a method of operating the same in accordance of the embodiment of the present disclosure, it capable of sequentially determining: the number of adsorption units required to operate in adsorption mode within the installation space; the durations needed for adsorption, heating, regeneration, and N₂ regeneration-cooling steps; and the total number of adsorption units so as to match the number of adsorption units required to operate in the determined adsorption mode.

Meanwhile, advantageous effects to be obtained from the present disclosure are not limited to those mentioned above, and other effects, which are not explicitly stated herein, will be readily understood by those of ordinary skill in the art from the following description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings of this specification exemplify a preferred embodiment of the present disclosure, the spirit of the present disclosure will be more clearly understood from the following detailed description taken in conjunction with the accompanying drawings, and thus it will be understood that the present disclosure is not limited to only contents illustrated in the accompanying drawings;

FIG. 1 is a conceptual view showing adsorbent conversion rate during adsorption-heating-CO₂ regeneration,

FIG. 2 is a conceptual view showing adsorbent conversion rate during adsorption-heating-CO₂ regeneration-N₂ regeneration,

FIG. 3A is a configuration view of a continuous direct air capture device during N₂ regeneration,

FIG. 3B is a configuration view of a continuous direct air capture device during CO₂ regeneration,

FIG. 4 is a configuration view of a continuous carbon dioxide capture system according to a first embodiment of the present disclosure,

FIG. 5 is a configuration view of a continuous carbon dioxide capture system according to a second embodiment of the present disclosure,

FIG. 6 is a configuration view of a continuous carbon dioxide capture system according to a third embodiment of the present disclosure, and

FIG. 7 is an operation timetable of the continuous carbon dioxide capture system according to the third embodiment of the present disclosure.

### DETAILED DESCRIPTION

Hereinafter, the aforementioned aims, other aims, features and advantageous effects of the present disclosure will be understood easily referring to preferable embodiments related to the accompanying drawings. However, the present disclosure is not limited to embodiments described in this specification, and may be embodied into other forms. Preferably, the embodiments in this specification are provided in order to allow disclosed contents to be exhaustive and to communicate the concept of the present disclosure to those skilled in the art.

In this specification, when a certain element is placed on another element, this means that it may be formed directly thereon or that the third element may be interposed between them. Further, in the drawings, the thickness of an element may be overstated in order to explain the technical content thereof efficiently.

The embodiments described in this specification will explained with reference to a cross-sectional view and/or a plane view. In the drawings, the thickness of a film and a region may be overstated in order to explain the technical content thereof efficiently. Accordingly, the form of exemplary drawings for a fabrication method and/or an allowable error et cetera may be reformed. Thus, the embodiments according to the present disclosure are not limited to specific forms illustrated herein, but may include variations in the form resulting from the fabrication method. For example, the region illustrated with perpendicular lines may have a form to be rounded or with a predetermined curvature. Thus, regions exemplified in the drawings have attributes, and shapes thereof exemplify specific forms rather than limiting the scope of the present disclosure. In the various embodiments of this specification, terms such as ‘first’ and ‘second’ et cetera are used to describe various elements, but these elements should not be limited to such terms. These terms are merely used to distinguish one element from others. The embodiments explained and exemplified herein may include complementary embodiments thereto.

The terms used in this specification is to explain the embodiments rather than limiting the present disclosure. In this specification, the singular expression includes the plural expression unless specifically stated otherwise. The terms, such as ‘comprise” and/or “comprising” do not preclude the potential existences of one or more elements.

When describing the following specific embodiments, various kinds of specific contents are made up to explain the present disclosure in detail and to help understanding thereof. However, it will be apparent for those who have knowledge to the extent of understanding the present disclosure that the present disclosure can be used without any of these specific contents. In a certain case when describing the present disclosure, the content that is commonly known to the public but is largely irrelevant to the present disclosure is not described in order to avoid confusion.

Hereinafter, the configuration, functions and operating method of a continuous carbon dioxide capture system for increasing adsorption efficiency and regeneration purity according to an embodiment will be described.

The continuous carbon dioxide capture system for increasing adsorption efficiency and regeneration purity according to an includes: a housing that includes an air inlet port through which external air is introduced and an outlet port through which carbon dioxide-removed air is discharged; and an adsorption unit that is installed within the housing and configured with a carbon dioxide adsorbent, wherein the adsorption unit is connected in plurality and sequentially undergoes an adsorption mode, a heating mode, a CO₂ regeneration mode, and a nitrogen regeneration-cooling mode, such that a set number of adsorption units always operate in the adsorption mode.

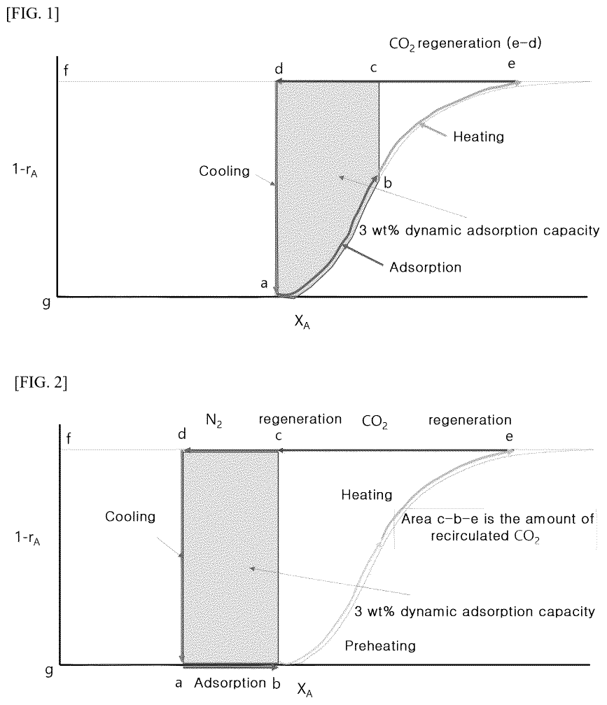

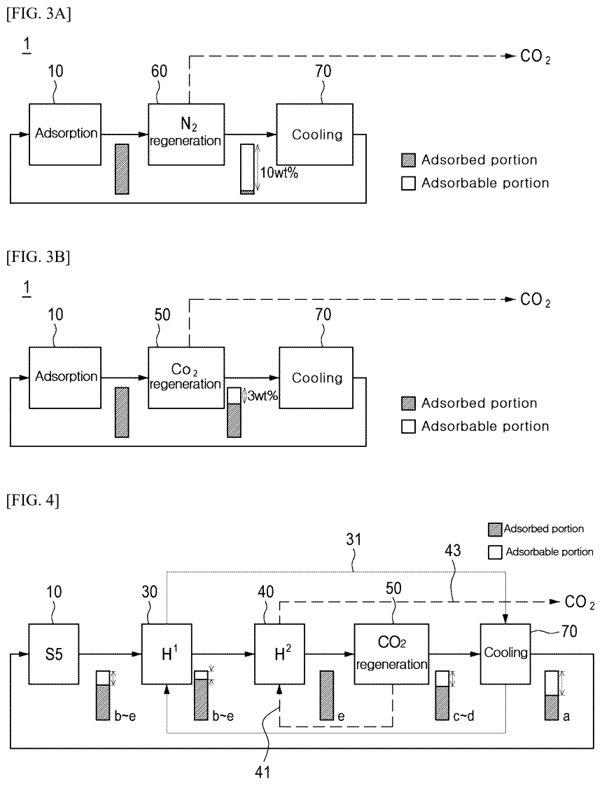

Firstly, FIG. 1 is a conceptual view showing adsorbent conversion rate during adsorption-heating-CO₂ regeneration. FIG. 2 is a conceptual view showing adsorbent conversion rate during adsorption-heating-CO₂ regeneration-N₂ regeneration. Further, FIG. 3A is a configuration view of a continuous direct air capture device 1 during N₂ regeneration, and FIG. 3B is a configuration view of a continuous direct air capture device 1 during CO₂ regeneration.

As shown in FIG. 1 and FIG. 2, when an adsorbent is regenerated with N₂, a dynamic adsorption capacity of approximately 10 wt % may be obtained (area g-a-b-e-f). In contrast, when the same adsorbent is regenerated with CO2, a dynamic adsorption capacity of approximately 3 wt % may be obtained (area a-b-c-d).

As an example of the conversion rate and reaction rate graph for a solid, a reaction rate remains constant until a conversion rate reaches a certain value, above which the reaction rate decreases. When a reaction rate of an adsorption column increases, even when the same amount of air is passed through, the amount of CO₂ captured increases, thereby improving the process performance. When N₂ regeneration is performed following CO₂ regeneration, even though an adsorption rate is the same as 3 wt % (area a-b-c-d), this corresponds to a region with a high reaction rate.

FIG. 4 is a configuration view of a continuous carbon dioxide capture system according to a first embodiment of the present disclosure. As shown in FIG. 4, an adsorption unit of the carbon dioxide capture system according to the first embodiment of the present disclosure continuously operates while repeatedly cycling through first to fifth adsorption modes 10, a first heating mode 30, a second heating mode 40, CO₂ regeneration mode 50, a cooling mode 70, the adsorption mode 10.

Furthermore, a cooling circulation line 21 circulates gas between an adsorption unit 10 in the first heating mode and an adsorption unit in the cooling mode 70. CO₂ discharged from an adsorption unit in the CO₂ regeneration mode 50 is discharged through an outlet line 43 via an adsorption unit in the second heating mode 40.

The adsorption of CO₂ proceeds in the cooling 70-first heating mode 30, and the adsorption of CO₂ becomes saturated in the regeneration 50-second heating mode 40.

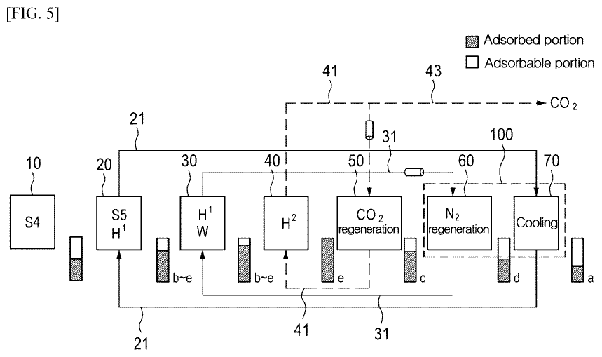

FIG. 5 is a configuration view of a continuous carbon dioxide capture system according to a second embodiment of the present disclosure.

Each of a plurality of adsorption units sequentially undergoes first to fourth adsorption modes 10, a preheating mode 20, a first heating mode 30, a second heating mode 40, a CO₂ regeneration mode 50, an N₂ regeneration 60-cooling 70 mode 100, and the first adsorption mode 10, and a set number of the adsorption units always operate in the adsorption mode.

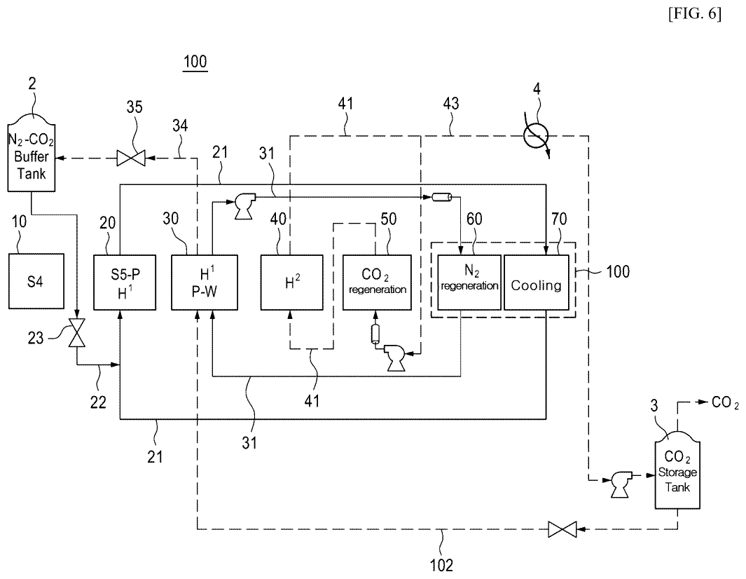

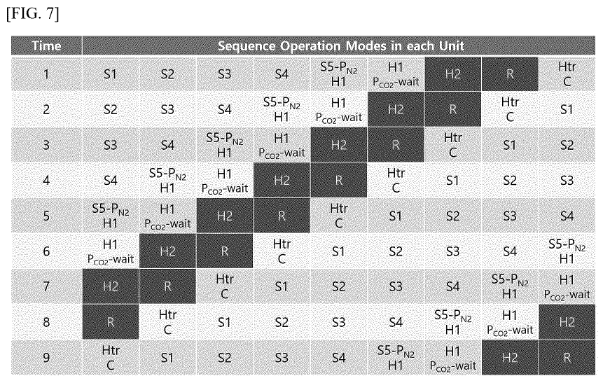

FIG. 6 is a configuration view of a continuous carbon dioxide capture system according to a third embodiment of the present disclosure. FIG. 7 is an operation timetable of the continuous carbon dioxide capture system according to the third embodiment of the present disclosure.

The operation mode of the third embodiment is substantially similar to that of the second embodiment, but features of N₂ purging and CO₂ purging are additionally included.

A first absorption mode 10, a second absorption mode 10, a third absorption mode 10, a fourth absorption mode 10, a preheating mode 20, a first heating mode 30, a second heating mode 40, a CO₂ regeneration mode 50, and an N₂ regeneration-cooling mode 100 are each carried out over the same time interval. For example, when each of the modes is set to 2 hours, the first, second, third and fourth adsorption modes 10 are each performed for 2 hours. The N₂ regeneration-cooling mode 100 is also performed for 2 hours, wherein the first hour corresponds to a N₂ regeneration step 60 and the remaining hour corresponds to a cooling step 70. The N₂ regeneration-cooling mode is operated in a single regeneration cooling unit.

A cooling circulation line 21 is included which connects an outlet port of an adsorption unit in the preheating mode 20 and an inlet port of an adsorption unit in a cooling step 70 of the N₂ regeneration-cooling mode, and connects an outlet port of the adsorption unit in the cooling step 70 of the N₂ regeneration-cooling mode and an inlet port of the adsorption unit in the preheating mode 20.

In the third embodiment, an N₂—CO₂ purge line 22 for purging N₂—CO₂ into the adsorption unit in preheating mode 20, and a first valve 23 provided on one side of the N₂—CO₂ purge line 22, are included.

In addition, an N₂ regeneration circulation line 31 is included which connects an outlet port of the adsorption unit in the first heating mode 30 and an inlet port of an adsorption unit in an N₂ regeneration step 60 of the N₂ regeneration-cooling mode 100, and connects an inlet port of the adsorption unit in the N₂ regeneration step 60 and an inlet port of the adsorption unit in the first heating mode 30.

Further, a CO₂ purge line 33 for purging CO₂ into the adsorption unit in the first heating mode 30 is included.

A discharge line 34 through which N₂—CO₂ is discharged from the adsorption unit in the first heating mode 30, and a second valve 35 provided on one side of the discharge line 34, may be included.

In addition, an N₂—CO₂ buffer tank 2 may be provided between the N₂—CO₂ purge line 22 and the discharge line 34.

Yet further, a regeneration circulation line 41 is included which connects an outlet port of the adsorption in the second heating mode 40 and an inlet port of the adsorption unit in the CO₂ regeneration mode 50, and connects an outlet port of the inlet port of the adsorption unit in the CO₂ regeneration mode 50 and an inlet port of the adsorption unit in the second heating mode 40.

A condensation line 43 may be included which is branched from a line that connects the outlet port of the adsorption unit in the second heating mode 40 and the inlet port of the adsorption unit in the CO₂ regeneration mode 50, and is connected to a CO₂ storage tank 3. Further, a moisture condensation part 4 may be included which is provided within the condensation line 43 to condense moisture.

In addition, the CO₂ purge line 33 is provided between the CO₂ storage tank 3 and the inlet port of the adsorption unit in the first heating mode 30, and a third valve is provided on one side of the CO₂ purge line 33.

Hereinafter, a method of operating the continuous carbon dioxide capture system for increasing adsorption efficiency and regeneration purity according to the aforementioned embodiment of the present disclosure will be described.

When the preheating mode 20 in which a cooling-preheating operation has completed is switched to the first heating mode 30, the CO₂ generated from the unit is mixed with N2 existing inside the unit, thereby diluting the concentration.

The space at the entry and exit portions of the unit is minimized, thereby minimizing dilution of the concentration caused by the gas remaining in the space. Since even the space filled with particles has 40˜60% void volume, dilution cannot be avoided even if the entry and exit portions of the unit are designed to be small.

Accordingly, in order to increase the concentration of the generated CO₂, the unit is purged with CO₂ and then switching to the first heating mode. The N₂—CO₂ gas generated during the purging is injected into an adsorption unit in the preheating mode during the cooling-preheating operation, thereby allowing CO₂ To be adsorbed. When the N₂—CO₂ gas is gradually injected, CO₂ is adsorbed, and the circulation interior is occupied by N₂ gas.

First, an adsorption unit in an adsorption mode 10 according to an embodiment of the present disclosure, allows external air to flow in through an inlet and allows carbon dioxide-removed air to be discharged through an outlet (First step). This adsorption mode may include first to fourth adsorption modes.

After the fourth adsorption mode is completed, an adsorption unit switched to a preheating mode 20 circulates gas through an adsorption unit in a cooling mode 70 and a cooling circulation line 21. During the preheating mode, N₂ may be purged into the adsorption unit for a certain purge period (Second step).

An adsorption unit switched to a first heating mode 30 circulate gas by an adsorption unit in an N₂ regeneration step of an N₂ regeneration-cooling mode and an N2 regeneration circulation line 31 (Third step).

In the third step, an outlet line 34 N2—CO2 is discharged through an outlet line 34 and stored in a buffer tank 20, allowing the N2—Co2 stored in the buffer tank 2 to be purged into an adsorption unit in the preheating mode 20.

Additionally, in third step, CO₂ may be purged into the adsorption unit. As previously mentioned, the CO₂ stored in a CO₂ storage tank 3 may be supplied to the adsorption unit in the first heating mode 30 through a CO2 purge line 33.

An adsorption unit switched to a second heating mode 40 circulates gas through an adsorption unit in a CO2 regeneration mode 50 and a regeneration line 40, and the CO₂ discharged through a condensation line 43 branched from one side of a regeneration circulation line 41 is stored in the CO₂ storage tank 3 (Fourth step).

An adsorption unit switched to a regeneration mode 50 circulates gas through the adsorption unit in the second heating mode 40 and the regeneration circulation line 41, and the CO₂ discharged through the condensation line 43 branched from one side of the regeneration circulation line 41 is stored in the CO₂ storage tank 3 (Fifth step).

An adsorption unit moved into a regeneration cooling unit 100 and switched into an N₂ regeneration mode 60 circulates gas through the adsorption unit in the first heating mode 30 and the N₂ regeneration circulation line 31 (Sixth step).

An adsorption unit switched to a cooling step within the regeneration cooling unit 100 circulates gas through the adsorption unit in the preheating mode 20 and the cooling circulation line 21 (Seventh step). Thereafter, an adsorption unit switched back to the first adsorption mode, and the first and seventh steps are repeated.

For example, as shown in FIG. 7, when the purge time is set to M minutes and the cycle time per mode is set to 2 hours:
(1) m minutes before reaching 1 hour, S5 (preheating mode)->N₂ purging (removing oxygen inside the unit; flow rate and time);
(2) At 1 hour: switching the operation from N₂ regeneration mode-preheating mode(H¹) to cooling-preheating mode H¹.
1) Turning off a heater is turned off, and switching the mode of S5-PN₂ to H1. Switching the existing H1 to a Wait mode (closing all valves).
2) Wait mode: after CO₂ purging, maintaining the operation until the next operation, in which the gas after CO₂ purging is stored in an N₂—CO₂ buffer tank.
3) When switching the S5-PN₂ to the preheating H¹ mode, allowing the CO₂ present in the cooling unit to circulate and be adsorbed into H1, thereby increasing the temperature.
4) Gradually introducing the gas in the N₂—CO₂ buffer tank into the cooling line, allowing CO₂ to be adsorbed so that only N₂ remains;
(3) At 2 hours: switching the operation to a C-A mode, and turning on Htr. R->Htr, H¹->H¹, Wait->H², H²->R, (preheating H¹: N₂ regenerated in a regeneration unit Htr; adsorbing CO₂, thereby increasing the temperature);
(4) At 3 hours: returning to the sequence (1) and then performing the same operations;
(5) Regeneration: after partially circulating 100% CO2, supplying it downstream the heater;
(6) Heating H²: after passing the gas from through the regeneration unit through a heating unit, storing CO₂ and circulating a portion thereof; and
(7) Cooling: under conditions in which 100% CO₂ is present, circulating the gas with the preheating unit, allowing only N₂ to ultimately remain.

Further, the configuration and method of the embodiments as described above are not restrictively applied to the aforementioned apparatus and method. The whole or part of the respective embodiments may be selectively combined so as to make various modifications of the embodiments.

### Figure Reference Numbers

1: continuous direct air capture device
2: buffer tank
3: CO₂ storage tank
4: moisture condensation part
10: adsorption mode
20: preheating mode
21: cooling circulation line
22: N₂—CO₂ purge line
23: first valve
30: first heating mode
31: N₂ regeneration circulation line
33: CO₂ purge line
34: outlet line
35: second valve
40: second heating mode
41: regeneration circulation line
43: CO₂ discharge line, condensation line
50: CO₂ regeneration mode
60: N₂ regeneration mode, N₂ regeneration step of N₂ regeneration-cooling mode
70: cooling mode, cooling step of N₂ regeneration-cooling mode
100: N₂ regeneration-cooling mode, regeneration cooling unit

1. As a continuous carbon dioxide capture system, a continuous carbon dioxide capture system for increasing adsorption efficiency and regeneration purity comprising:
a housing that includes an air inlet port through which external air is introduced and an outlet port through which carbon dioxide-removed air is discharged; and
an adsorption unit that is installed within the housing and configured with a carbon dioxide adsorbent, wherein
the adsorption unit is connected in plurality and sequentially undergoes an adsorption mode, a heating mode, a CO₂ regeneration mode, and a nitrogen regeneration-cooling mode, such that a set number of adsorption units always operate in the adsorption mode; and
a regeneration circulation line that connects an adsorption unit in the heating mode to an adsorption unit in the regeneration mode.

2. The continuous carbon dioxide capture system for increasing adsorption efficiency and regeneration purity of claim 1, wherein
each of the plurality of adsorption units sequentially undergoes an adsorption mode, a preheating mode, a first heating mode, a second heating mode, a CO2 regeneration mode, an N2 regeneration-cooling mode, and an adsorption mode, and a set number of the adsorption units always operate in the adsorption mode.

3. The continuous carbon dioxide capture system for increasing adsorption efficiency and regeneration purity of claim 2, further comprising:
a cooling circulation line that connects an outlet port of the adsorption unit in the preheating mode and an inlet port of an adsorption unit in a cooling step of the N₂ regeneration-cooling mode, and connects an outlet port of the adsorption unit in the cooling step of the N₂ regeneration-cooling mode and an inlet port of the adsorption unit in the preheating mode.

4. The continuous carbon dioxide capture system for increasing adsorption efficiency and regeneration purity of claim 3, further comprising:
an N₂—CO₂ purge line for purging N₂—CO₂ into the adsorption unit in preheating mode; and
a first valve provided on one side of the N₂—CO₂ purge line.

5. The continuous carbon dioxide capture system for increasing adsorption efficiency and regeneration purity of claim 4, further comprising:
an N₂ regeneration circulation line that connects an outlet port of the adsorption unit in the first heating mode and an inlet port of an adsorption unit in an N₂ regeneration step of the N₂ regeneration-cooling mode, and connects an inlet port of the adsorption unit in the N₂ regeneration step and an inlet port of the adsorption unit in the first heating mode; and
a CO₂ purge line for purging CO₂ into the adsorption unit in the first heating mode.

6. The continuous carbon dioxide capture system for increasing adsorption efficiency and regeneration purity of claim 5, further comprising:
a discharge line through which N₂—CO₂ is discharged from the adsorption unit in the first heating mode; and
a second valve provided on one side of the discharge line.

7. The continuous carbon dioxide capture system for increasing adsorption efficiency and regeneration purity of claim 6, further comprising:
an N₂—CO₂ buffer tank provided between the N₂—CO₂ purge line and the discharge line.

8. The continuous carbon dioxide capture system for increasing adsorption efficiency and regeneration purity of claim 7, further comprising:
a regeneration circulation line that connects an outlet port of the adsorption in the second heating mode and an inlet port of the adsorption unit in the CO₂ regeneration mode, and connects an outlet port of the inlet port of the adsorption unit in the CO₂ regeneration mode and an inlet port of the adsorption unit in the second heating mode.

9. The continuous carbon dioxide capture system for increasing adsorption efficiency and regeneration purity of claim 8, further comprising:
a condensation line branched from a line that connects the outlet port of the adsorption unit in the second heating mode and the inlet port of the adsorption unit in the CO₂ regeneration mode, and connected to a CO₂ storage tank; and
a moisture condensation part provided within the condensation line to condense moisture.

10. The continuous carbon dioxide capture system for increasing adsorption efficiency and regeneration purity of claim 9, wherein
the CO₂ purge line is provided between the CO₂ storage tank and the inlet port of the adsorption unit in the first heating mode, and
further comprising a third valve provided on one side of the CO₂ purge line.

11. As a method of operating the continuous carbon dioxide capture system according to claim 1, a method of operating the continuous carbon dioxide capture system for increasing adsorption efficiency and regeneration purity comprising:
a first step in which an adsorption unit in an adsorption mode allows external air to be introduced through an inlet port, and discharges carbon dioxide-removed air through an outlet port;
a second step in which an adsorption unit switched to a preheating mode circulates gas through an adsorption unit in a cooling step of an N₂ regeneration-cooling mode and cooling circulation line;
a third step in which an adsorption unit switched to a first heating mode circulates gas through the adsorption unit in the cooling step of the N₂ regeneration-cooling mode and an N₂ regeneration line;
a fourth step in which an adsorption unit switched to a second heating mode circulates gas through an adsorption unit in a CO₂ regeneration mode and a regeneration circulation line, and CO₂ discharged through a condensation line branched from one side of the regeneration circulation line is stored in a CO₂ storage tank;
a fifth step in which an adsorption switched to a regeneration mode circulates gas through the adsorption unit switched to the second heating mode and the regeneration circulation line, and CO₂ discharged through the condensation line branched from one side of the regeneration circulation line is stored in the CO₂ storage tank;
a sixth step in which an adsorption unit moved into a regeneration-cooling unit and switched to an N₂ regeneration step of the N₂ regeneration-cooling mode circulates gas through the adsorption unit in the first heating mode and the N2 regeneration circulation line;
a seventh step in which an adsorption unit switched to a cooling step of the N₂ regeneration-cooling mode circulates gas through the adsorption unit in the preheating mode and the cooling circulation line; and
a step of repeating the first step to the seventh step.

12. The method of operating the continuous carbon dioxide capture system for increasing adsorption efficiency and regeneration purity of claim 11, wherein
in the second step, N₂ is purged to the adsorption unit, and
in the third step, CO₂ is purged to the adsorption unit purges.

13. The method of operating the continuous carbon dioxide capture system for increasing adsorption efficiency and regeneration purity of claim 12, wherein
in the third step, N₂—CO₂ is discharged through an outlet line and stored in a buffer tank, and
the N₂—CO₂ stored in the buffer tank is purged to the adsorption unit in the second step.

14. The method of operating the continuous carbon dioxide capture system for increasing adsorption efficiency and regeneration purity of claim 13, wherein
the CO₂ stored in the CO₂ storage tank is supplied to the adsorption unit in the first heating unit through a CO₂ purge line.

15. As a method of operating the continuous carbon dioxide capture system according to claim 2, a method of operating the continuous carbon dioxide capture system for increasing adsorption efficiency and regeneration purity comprising:
a first step in which an adsorption unit in an adsorption mode allows external air to be introduced through an inlet port, and discharges carbon dioxide-removed air through an outlet port;
a second step in which an adsorption unit switched to a preheating mode circulates gas through an adsorption unit in a cooling step of an N₂ regeneration-cooling mode and cooling circulation line;
a third step in which an adsorption unit switched to a first heating mode circulates gas through the adsorption unit in the cooling step of the N₂ regeneration-cooling mode and an N₂ regeneration line;
a fourth step in which an adsorption unit switched to a second heating mode circulates gas through an adsorption unit in a CO₂ regeneration mode and a regeneration circulation line, and CO₂ discharged through a condensation line branched from one side of the regeneration circulation line is stored in a CO₂ storage tank;
a fifth step in which an adsorption switched to a regeneration mode circulates gas through the adsorption unit switched to the second heating mode and the regeneration circulation line, and CO₂ discharged through the condensation line branched from one side of the regeneration circulation line is stored in the CO₂ storage tank;
a sixth step in which an adsorption unit moved into a regeneration-cooling unit and switched to an N₂ regeneration step of the N₂ regeneration-cooling mode circulates gas through the adsorption unit in the first heating mode and the N2 regeneration circulation line;
a seventh step in which an adsorption unit switched to a cooling step of the N₂ regeneration-cooling mode circulates gas through the adsorption unit in the preheating mode and the cooling circulation line; and
a step of repeating the first step to the seventh step.

16. As a method of operating the continuous carbon dioxide capture system according to claim 3, a method of operating the continuous carbon dioxide capture system for increasing adsorption efficiency and regeneration purity comprising:
a first step in which an adsorption unit in an adsorption mode allows external air to be introduced through an inlet port, and discharges carbon dioxide-removed air through an outlet port;
a second step in which an adsorption unit switched to a preheating mode circulates gas through an adsorption unit in a cooling step of an N₂ regeneration-cooling mode and cooling circulation line;
a third step in which an adsorption unit switched to a first heating mode circulates gas through the adsorption unit in the cooling step of the N₂ regeneration-cooling mode and an N₂ regeneration line;
a fourth step in which an adsorption unit switched to a second heating mode circulates gas through an adsorption unit in a CO₂ regeneration mode and a regeneration circulation line, and CO₂ discharged through a condensation line branched from one side of the regeneration circulation line is stored in a CO₂ storage tank;
a fifth step in which an adsorption switched to a regeneration mode circulates gas through the adsorption unit switched to the second heating mode and the regeneration circulation line, and CO₂ discharged through the condensation line branched from one side of the regeneration circulation line is stored in the CO₂ storage tank;
a sixth step in which an adsorption unit moved into a regeneration-cooling unit and switched to an N₂ regeneration step of the N₂ regeneration-cooling mode circulates gas through the adsorption unit in the first heating mode and the N2 regeneration circulation line;
a seventh step in which an adsorption unit switched to a cooling step of the N₂ regeneration-cooling mode circulates gas through the adsorption unit in the preheating mode and the cooling circulation line; and
a step of repeating the first step to the seventh step.

17. As a method of operating the continuous carbon dioxide capture system according to claim 4, a method of operating the continuous carbon dioxide capture system for increasing adsorption efficiency and regeneration purity comprising:
a first step in which an adsorption unit in an adsorption mode allows external air to be introduced through an inlet port, and discharges carbon dioxide-removed air through an outlet port;
a second step in which an adsorption unit switched to a preheating mode circulates gas through an adsorption unit in a cooling step of an N₂ regeneration-cooling mode and cooling circulation line;
a third step in which an adsorption unit switched to a first heating mode circulates gas through the adsorption unit in the cooling step of the N₂ regeneration-cooling mode and an N₂ regeneration line;
a fourth step in which an adsorption unit switched to a second heating mode circulates gas through an adsorption unit in a CO₂ regeneration mode and a regeneration circulation line, and CO₂ discharged through a condensation line branched from one side of the regeneration circulation line is stored in a CO₂ storage tank;
a fifth step in which an adsorption switched to a regeneration mode circulates gas through the adsorption unit switched to the second heating mode and the regeneration circulation line, and CO₂ discharged through the condensation line branched from one side of the regeneration circulation line is stored in the CO₂ storage tank;
a sixth step in which an adsorption unit moved into a regeneration-cooling unit and switched to an N₂ regeneration step of the N₂ regeneration-cooling mode circulates gas through the adsorption unit in the first heating mode and the N2 regeneration circulation line;
a seventh step in which an adsorption unit switched to a cooling step of the N₂ regeneration-cooling mode circulates gas through the adsorption unit in the preheating mode and the cooling circulation line; and
a step of repeating the first step to the seventh step.

18. As a method of operating the continuous carbon dioxide capture system according to claim 5, a method of operating the continuous carbon dioxide capture system for increasing adsorption efficiency and regeneration purity comprising:
a first step in which an adsorption unit in an adsorption mode allows external air to be introduced through an inlet port, and discharges carbon dioxide-removed air through an outlet port;
a second step in which an adsorption unit switched to a preheating mode circulates gas through an adsorption unit in a cooling step of an N₂ regeneration-cooling mode and cooling circulation line;
a third step in which an adsorption unit switched to a first heating mode circulates gas through the adsorption unit in the cooling step of the N₂ regeneration-cooling mode and an N₂ regeneration line;
a fourth step in which an adsorption unit switched to a second heating mode circulates gas through an adsorption unit in a CO₂ regeneration mode and a regeneration circulation line, and CO₂ discharged through a condensation line branched from one side of the regeneration circulation line is stored in a CO₂ storage tank;
a fifth step in which an adsorption switched to a regeneration mode circulates gas through the adsorption unit switched to the second heating mode and the regeneration circulation line, and CO₂ discharged through the condensation line branched from one side of the regeneration circulation line is stored in the CO₂ storage tank;
a sixth step in which an adsorption unit moved into a regeneration-cooling unit and switched to an N₂ regeneration step of the N₂ regeneration-cooling mode circulates gas through the adsorption unit in the first heating mode and the N2 regeneration circulation line;
a seventh step in which an adsorption unit switched to a cooling step of the N₂ regeneration-cooling mode circulates gas through the adsorption unit in the preheating mode and the cooling circulation line; and
a step of repeating the first step to the seventh step.

19. As a method of operating the continuous carbon dioxide capture system according to claim 6, a method of operating the continuous carbon dioxide capture system for increasing adsorption efficiency and regeneration purity comprising:
a first step in which an adsorption unit in an adsorption mode allows external air to be introduced through an inlet port, and discharges carbon dioxide-removed air through an outlet port;
a second step in which an adsorption unit switched to a preheating mode circulates gas through an adsorption unit in a cooling step of an N₂ regeneration-cooling mode and cooling circulation line;
a third step in which an adsorption unit switched to a first heating mode circulates gas through the adsorption unit in the cooling step of the N₂ regeneration-cooling mode and an N₂ regeneration line;
a fourth step in which an adsorption unit switched to a second heating mode circulates gas through an adsorption unit in a CO₂ regeneration mode and a regeneration circulation line, and CO₂ discharged through a condensation line branched from one side of the regeneration circulation line is stored in a CO₂ storage tank;
a fifth step in which an adsorption switched to a regeneration mode circulates gas through the adsorption unit switched to the second heating mode and the regeneration circulation line, and CO₂ discharged through the condensation line branched from one side of the regeneration circulation line is stored in the CO₂ storage tank;
a sixth step in which an adsorption unit moved into a regeneration-cooling unit and switched to an N₂ regeneration step of the N₂ regeneration-cooling mode circulates gas through the adsorption unit in the first heating mode and the N2 regeneration circulation line;
a seventh step in which an adsorption unit switched to a cooling step of the N₂ regeneration-cooling mode circulates gas through the adsorption unit in the preheating mode and the cooling circulation line; and
a step of repeating the first step to the seventh step.

20. As a method of operating the continuous carbon dioxide capture system according to claim 7, a method of operating the continuous carbon dioxide capture system for increasing adsorption efficiency and regeneration purity comprising:
a first step in which an adsorption unit in an adsorption mode allows external air to be introduced through an inlet port, and discharges carbon dioxide-removed air through an outlet port;
a second step in which an adsorption unit switched to a preheating mode circulates gas through an adsorption unit in a cooling step of an N₂ regeneration-cooling mode and cooling circulation line;
a third step in which an adsorption unit switched to a first heating mode circulates gas through the adsorption unit in the cooling step of the N₂ regeneration-cooling mode and an N₂ regeneration line;
a fourth step in which an adsorption unit switched to a second heating mode circulates gas through an adsorption unit in a CO₂ regeneration mode and a regeneration circulation line, and CO₂ discharged through a condensation line branched from one side of the regeneration circulation line is stored in a CO₂ storage tank;
a fifth step in which an adsorption switched to a regeneration mode circulates gas through the adsorption unit switched to the second heating mode and the regeneration circulation line, and CO₂ discharged through the condensation line branched from one side of the regeneration circulation line is stored in the CO₂ storage tank;
a sixth step in which an adsorption unit moved into a regeneration-cooling unit and switched to an N₂ regeneration step of the N₂ regeneration-cooling mode circulates gas through the adsorption unit in the first heating mode and the N2 regeneration circulation line;
a seventh step in which an adsorption unit switched to a cooling step of the N₂ regeneration-cooling mode circulates gas through the adsorption unit in the preheating mode and the cooling circulation line; and
a step of repeating the first step to the seventh step.
